(19) United States
(12) Patent Application Publication
(10) Pub. No.: US 2011/0117372 A1
(43) Pub. Date: May 19, 2011

(54) GRAPHENE OR GRAPHITE THIN FILM, MANUFACTURING METHOD THEREOF, THIN FILM STRUCTURE AND ELECTRONIC DEVICE

(75) Inventors: Maki Suemitsu, Sendai-shi (JP); Atsushi Konno, Sendai-shi (JP); Yu Miyamoto, Sendai-shi (JP)

(73) Assignee: TOHOKU UNIVERSITY, Sendai-shi (JP)

(21) Appl. No.: 12/921,478

(22) PCT Filed: Mar. 9, 2009
(86) PCT No.: PCT/JP2009/054384

§ 371 Date: Dec. 21, 2010

(30) Foreign Application Priority Data
Mar. 10, 2008 (JP) 2008-060097

(51) Int. Cl. B05D 5/12; B32B 9/04

(52) U.S. Cl. 428/446; 427/122

(57) ABSTRACT

Provided are a high-quality graphene or graphite thin film compatible with a large surface area, a manufacturing method that can epitaxially form the graphene or graphite thin film on a Si substrate, a thin film structure, and an electronic device having the same. The present invention provides a graphene or graphite thin film formed on a cubic SiC crystal thin film having a (111) orientation formed on a Si substrate, the cubic SiC crystal thin film being used as a base material. Additionally, the development of ultra-high-speed devices that support next-generation high-speed communication services can be advanced by means of an electronic device having a graphene or graphite thin film structure grown as a crystal on a substrate.

### TECHNICAL FIELD

The present invention relates to a graphite thin film in which graphene is formed on the surface of a Si substrate and graphite is grown thereon, a manufacturing method thereof, a thin film structure, and an electronic device having the same.

### BACKGROUND ART

Recently, research and development of thin films formed on Si substrates using various materials have been conducted for use as materials for high-speed electronic devices that support next-generation high-speed communication services. To obtain materials for ultra-high-speed electronic devices, a technique of forming graphene on cubic SiC thin films epitaxially formed on Si(100) substrates has been attracted attention. According to this technique, a cubic SiC thin film having a plane orientation (100) formed on a Si(100) substrate is heated at a temperature of 1,200 to 1,300° C. in vacuum, thereby forming the outermost surface of the SiC thin film into a graphene thin film.

Graphene is a two-dimensional sheet of carbon crystals in which carbon atoms form hexagonal meshes. Graphene sheets can be laminated to form graphite.

Regarding graphene thin films, a technique of heating cubic SiC previously formed on Si(100) substrates at 1,050 to 1,080° C. in vacuum, thereby forming graphene thin films on the surface of the substrates is disclosed (e.g., see NPL 1).

In this technique, however, graphite or graphene thin films with three-fold symmetry must be formed on Si(100) substrates with two-fold symmetry; it was difficult to form high-quality graphene thin films or graphite.

Another method of forming graphene thin films or graphite on Si substrates is a technique of heating hexagonal SiC crystals at a temperature of 1,300 to 1,400° C. in vacuum, thereby forming graphite on the surface of the crystals. The formed graphite layers are peeled off with an adhesive tape, and then transferred on thermally-oxidized films formed on Si substrates. Conventionally, for example, hexagonal SiC is heated at 1,300 to 1,350° C. in vacuum, thereby forming a graphene thin film on the surface thereof (e.g., see NPL 2 or NPL 3).

The present inventor et al. reveal that a cubic SiC (3C—SiC) crystal having an orientation (111) is grown on a Si(110) substrate; and that particularly when the thickness of SiC is 3 ML (atomic layer) or more, growing the SiC(111) surface on the Si(110) surface is energetically most stable, and when the SiC thickness is 8 mL or more, a substrate with a vicinal angle of 2.5° is energetically more stable (e.g., see NPL 4).

[NPL 1] Andreas Sandin, J. L. Tedesco, R. J. Nemanich, J. E. (Jack) Rowe, “Interface Studies of Graphene layers on SiC thin films and bulk SiC(0001)”, [online], March, 2008, American Physical Society, Internet address <http://absimage.aps.org/image/MWSMAR08-2007-006961.pdf>

[NPL 2] X. N. Xie, H. Q. Wang, A. T. S. Wee, Klan ping Loh, “The evolution of 3×3, 6×6, √3×√3R30° and 6√3×6√3R30° superstructures on 6H—SiC(0001) surfaces studied by reflection high energy electron diffraction”, Surf. Sci., 2001, 478, p. 57-71

[NPL 3] Joshua Moskowitz, Patrick Ho, Daniel Kuncik, “Princeton Center for Complex Materials”, REU (Research Experience for Undergraduates) Research Projects Summer 2006

[NPL 4] Tomonori Ito, Toru Konno, Toru Akiyama, Kohji Nakamura, Atsushi Konno, Maki Suemitsu, “Empirical Potential Approach to the Formation of 3C—SiC/Si(110)”, Appl. Phys. Express, Oct. 31, 2008, Vol. 1, No. 11, 111201

### SUMMARY OF THE INVENTION

### Technical Problem

However, there were problems that it was difficult to directly epitaxially grow high-quality graphene or graphite on a Si substrate via a SIC thin film to form a desired thin film, and that the conditions of a semiconductor process were not clear. Another problem was that the quality of such a thin film was much far from a practical level. In contrast, the transfer method had drawbacks that a large surface area was hardly achieved because of the restrictions on SIC substrates, and that this method was not suitable for mass production in principle.

The present invention has been made in view of these problems, and an object of the present invention is to provide a high-quality graphene or graphite thin film compatible with a large surface area, a manufacturing method for epitaxially forming the graphene or graphite thin film on a Si substrate, a thin film structure, and an electronic device having the same.

### Solution to Problem

In order to achieve the above object, the graphene or graphite thin film of the present invention is formed on a cubic SiC crystal thin film having a (111) orientation formed on a Si substrate, the cubic SiC crystal thin film being used as a base material.

The method of manufacturing the graphene or graphite thin film of the present invention comprises forming a cubic SiC crystal thin film having a (111) orientation on a Si substrate, and forming a graphene or graphite thin film on the cubic SiC crystal thin film that is used as a base material.

The thin film structure of the present invention comprises a Si substrate, a cubic SiC crystal thin film having a (111) orientation formed on the Si substrate, and a graphene or graphite thin film formed on the cubic SiC crystal thin film that is used as a base material.

For the graphene or graphite thin film, manufacturing method thereof, and thin film structure of the present invention, the cubic SiC crystal thin film formed on the Si substrate preferably has a (111) orientation; however, the orientation may deviate by about 5 degrees or less from the (111) orientation.

In the graphene or graphite thin film of the present invention, the cubic SiC crystal thin film is preferably a SiC thin film formed on a Si(111) substrate. In the method of manufacturing the graphene or graphite thin film of the present invention, the cubic SiC crystal thin film is preferably formed on a Si(111) substrate. In the thin film structure of the present invention, the cubic SiC crystal thin film is preferably a SiC thin film formed on a Si(111) substrate. In these cases, the Si substrate is preferably a Si(111) substrate; however, the substrate may deviate by about 5 degrees or less from the Si(111) substrate.

In the graphene or graphite thin film of the present invention, the cubic SiC crystal thin film may be a SiC thin film formed on a Si(110) substrate. In the method of manufacturing the graphene or graphite thin film of the present invention, the cubic SIC crystal thin film may be formed on a Si(110) substrate. In the thin film structure of the present invention, the cubic SiC crystal thin film may be a SiC thin film formed on a Si(110) substrate. In these cases, the Si substrate is preferably a Si(110) substrate; however, the substrate may deviate by about 5 degrees or less from the Si(110) substrate.

The graphene or graphite thin film of the present invention is preferably formed by heating the cubic SIC crystal thin film at a temperature of 1,200 to 1,400° C. in vacuum to evaporate and remove the Si component near the surface of the film. In the method of manufacturing a graphene or graphite thin film of the present invention, the cubic SiC crystal thin film is preferably heated at a temperature of 1,200 to 1,400° C. in vacuum to evaporate and remove the Si component near the surface of the cubic SiC crystal thin film, thereby forming a graphene or graphite thin film. In these cases, since the cubic SiC crystal thin film is made of cubic SiC crystals in a laminated form, removal of the Si component present near the surface of the cubic SIC crystal thin film, more specifically, in the space between the surface of the cubic SIC crystal thin film and a predetermined depth, allows the formation of a graphene or graphite thin film with the remaining C component, on the cubic SiC crystal thin film, from which the Si component is not removed.

In the graphene or graphite thin film of the present invention, the cubic SiC crystal thin film is preferably formed using an organosilicon gas having a Si—H bond and a Si—C bond. In the graphene or graphite thin film of the present invention, the organosilicon gas preferably comprises at least one of monomethylsilane, dimethylsilane, and trimethylsilane. In the method of manufacturing the graphene or graphite thin film of the present invention, the cubic SiC crystal thin film is preferably formed using an organosilicon gas having a Si—H bond and a Si—C bond. In the method of manufacturing the graphene or graphite thin film of the present invention, the organosilicon gas preferably comprises at least one of monomethylsilane, dimethylsilane, and trimethylsilane.

The electronic device of the present invention comprises the graphene or graphite thin film of the present invention, or the thin film structure of the present invention.

### Advantageous Effects of Invention

The present invention can form graphene or graphite thin films on SiC substrates. Since the formation of graphite thin films has been confirmed, even when graphite thin films are repeatedly laminated, the flatness of the upper layer of the laminated graphite thin films can be maintained and stabilized, establishing highly effective technology for developing materials for high-speed electronic devices that support next-generation high-speed communication services.

The present invention can provide a high-quality graphene or graphite thin film compatible with a large surface area, a manufacturing method for epitaxially forming the graphene or graphite thin film on a Si substrate, a thin film structure, and an electronic device having the same.

### BRIEF DESCRIPTION OF DRAWINGS

FIG. 1 is a structural diagram showing an example of a semiconductor manufacturing device for SiC thin film growth used in the method of manufacturing the graphene or graphite thin film according to an embodiment of the present invention.

FIG. 2 is a graph showing the X-ray diffraction of a 3C—SiC thin film formed on a Si substrate by the method of manufacturing the graphene thin film according to an embodiment of the present invention using the semiconductor manufacturing device shown in FIG. 1.

FIG. 3 is an optical micrograph of graphene grown on a Si substrate by the method of manufacturing the graphene thin film according to an embodiment of the present invention using the semiconductor manufacturing device shown in FIG. 1.

FIG. 4 is a graph showing the results of Raman-scattering spectrum analysis demonstrating that the formation of graphene was verified as a result of modification of 3C—SiC(111)/Si(111) by the method of manufacturing the graphene thin film according to an embodiment of the present invention.

### DESCRIPTION OF EMBODIMENTS

Embodiments of the present invention are described in detail below with reference to drawings.

The present invention is not limited to the embodiments described below.

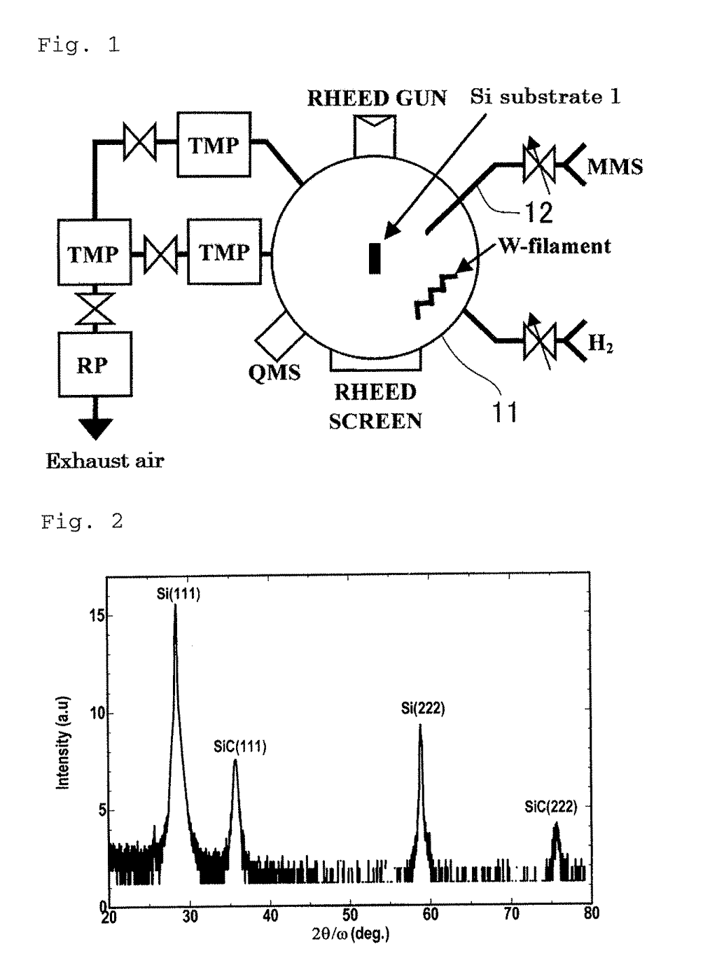

FIG. 1 schematically shows a structure of a semiconductor manufacturing device for SiC thin film growth, which is the basic concept of the present invention. The semiconductor manufacturing device comprises a vacuum chamber 11 equipped with two turbo molecular pumps (TMPs), and has the function of achieving a pressure of 10⁻⁸ Pa or less by removing the air from the vacuum chamber 11.

A method of forming a graphene or graphite thin film using this semiconductor manufacturing device is described.

First, a Si substrate 1 is placed in the vacuum chamber 11 of the semiconductor manufacturing device, and vacuuming is performed to reach a pressure of 10⁻⁷ Pa or less. Then, the Si substrate 1 is heated to 900 to 1,000° C. by controlling a temperature controller (not shown). After the Si substrate 1 is heated, monomethylsilane (MMSi) is injected into the vacuum chamber 11 at a pressure of 10⁻⁴ to 10⁻² Pa by a gas injection pipe 12 provided in the semiconductor manufacturing device. As a result of film formation for about 1 hour, a cubic SiC (3C—SiC) thin film is formed.

Next, a method of forming a graphene or graphite thin film on the Si substrate 1 is described.

The formation of a graphene or graphite thin film necessitates the use of a SiC crystal surface with the same three-fold symmetry. That is, when the Si substrate 1 is used, it is necessary to epitaxially grow SiC on the Si substrate 1, and therefore, a cubic (3C—)SiC, which is only polytype SiC capable of growing on the Si substrate 1, must be used as the SiC crystal.

More specifically, a 3C—SiC(111) surface with three-fold symmetry is used as the SiC crystal plane orientation.

In order to easily form a 3C—SiC(111) surface, for example, a semiconductor process in which a Si(111) substrate is used, and a 3C—SiC(111) surface is epitaxially grown on the substrate, is required.

In the present invention, considering the examples described above, a film formation technique of performing chemical vapor deposition on a Si(110) substrate or Si(111) substrate using an organosilane gas as a catalyst was used in the semiconductor process for the formation of a 3C—SiC(111) thin film on a Si substrate. Using this film formation technique, a 3C—SiC(111) surface is formed on a Si (110) substrate or Si (111) substrate.

The comparison of the 3C—SiC(111) thin film formed on the Si(110) substrate with the 3C—SiC(111) thin film formed on the Si(111) substrate as a result of 3C—SiC(111) thin film formation on the Si substrates of the present invention reveals that in the 3C—SiC(111) thin film formed on the Si (110) substrate, the crystal distortion is reduced to about one fourth, and a high-quality thin film can be obtained.

Subsequently, a method of forming a 3C—SiC(111) thin film and graphene thin film on a Si(111) substrate is described.

First, a 3C—SiC(111) thin film is grown by chemical vapor deposition on the Si(111) substrate 1 placed in the vacuum chamber 11 of the semiconductor manufacturing device shown in FIG. 1 using an organosilane gas as a catalyst. FIG. 2 shows an X-ray diffraction diagram of the 3C—SiC(111) thin film formed on the Si(111) substrate. As is clear from the peaks in FIG. 2, 3C—SiC(111) is formed on the Si (111) substrate.

Thereafter, heat treatment (annealing treatment) is carried out at 1,200° C. in vacuum for 10 minutes to evaporate and remove the Si component near the surface of the 3C—SiC(111) thin film, thereby forming a graphene thin film on the surface of the Si substrate 1.

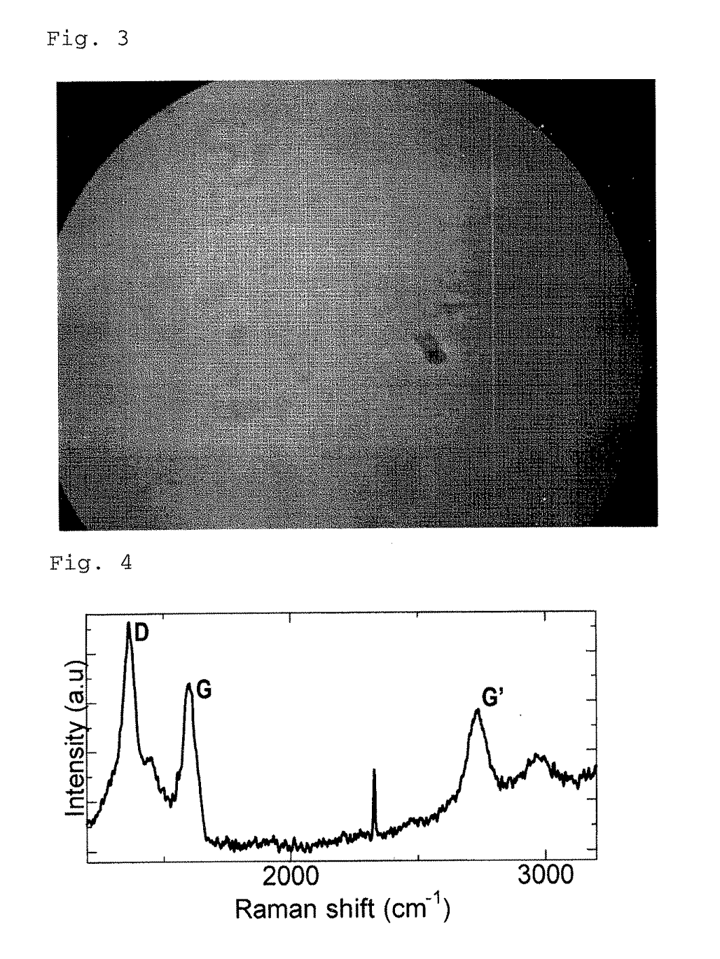

FIG. 3 is an optical micrograph of the graphene thin film formed on the surface of the 3C—SiC(111)/Si(111) substrate.

The graphene thin film described above is explained as follows.

FIG. 4 shows the results of Raman-scattering spectrum analysis demonstrating that the formation of graphene was verified as a result of modification of 3C—SiC(111)/Si(111). As is clear from FIG. 4, peak G and peak G′ both correspond to a Raman process that excites a specific oscillation mode of carbon atoms in graphene. The peaks differ in symmetry of oscillation mode. Peak G′ is often used in the evaluation of graphene because it sensitively reflects the electronic states (appearance of the valence band and conduction band) of graphene.

FIG. 4 demonstrates that 3C—SiC(111) is formed on the Si(111) substrate, and its spectrum is equivalent to that of graphene having a defect. The fact that the spectrum is equivalent to that from bulk graphite crystals indicates that graphene is formed on the surface of the Si(111) substrate via the SiC thin film. Peak D in FIG. 4 normally does not appear in perfect graphene; the appearance of this peak implies that the graphene film still has a defect.

The present invention that forms graphene thin films in this manner is said to provide a technical clue for forming graphene thin films on the surface of SiC substrates having a larger surface area. By forming a graphene thin film on a SiC substrate, even when graphene thin films are repeatedly laminated, the flatness of the upper layer of the laminated graphene thin films can be maintained and stabilized. Accordingly, a high-quality graphene thin film compatible with a large surface area can be formed.

### INDUSTRIAL APPLICABILITY

The method of manufacturing the graphene or graphite thin film of the present invention can be practiced by slight modification of a practical semiconductor manufacturing device, and high-quality graphene and graphite thin films can be formed by this method.

The present invention is not limited to these examples and can be suitably changed without departing from the scope of the present invention. The properties of the thin film suitably vary depending on the atmosphere, such as heat treatment conditions, the optimization of the lattice constant, etc.

### REFERENCE SIGNS LIST

1. Si substrate (Si(111) substrate)
11. Vacuum chamber
12. Gas injection pipe

1. A graphene or graphite thin film, which is formed on a cubic SiC crystal thin film having a (111) orientation formed on a Si substrate, the cubic SiC crystal thin film being used as a base material.

2. The graphene or graphite thin film according to claim 1, wherein the cubic SiC crystal thin film is a SiC thin film formed on a Si(111) substrate.

3. The graphene or graphite thin film according to claim 1, wherein the cubic SiC crystal thin film is a SiC thin film formed on a Si(110) substrate.

4. The graphene or graphite thin film according to claim 1, which is formed by heating the cubic SiC crystal thin film at a temperature of 1,200 to 1,400° C. in vacuum to evaporate and remove the Si component near the surface of the cubic SiC crystal thin film.

5. The graphene or graphite thin film according to claim 1, wherein the cubic SiC crystal thin film is formed using an organosilicon gas having a Si—H bond and a Si—C bond.

6. The graphene or graphite thin film according to claim 5, wherein the organosilicon gas comprises at least one of monomethylsilane, dimethylsilane, and trimethylsilane.

7. A method of manufacturing a graphene or graphite thin film, the method comprising:
forming a cubic SiC crystal thin film having a (111) orientation on an Si substrate; and
forming a graphene or graphite thin film on the cubic SIC crystal thin film that is used as a base material.

8. The manufacturing method according to claim 7, wherein the cubic SiC crystal thin film is formed on a Si(111) substrate.

9. The manufacturing method according to claim 7, wherein the cubic SiC crystal thin film is formed on a Si(110) substrate.

10. The manufacturing method according to claim 7, wherein the cubic SiC crystal thin film is heated at a temperature of 1,200 to 1,400° C. in vacuum to evaporate and remove the Si component near the surface of the cubic SiC crystal thin film, thereby forming a graphene or graphite thin film.

11. The manufacturing method according to claim 7, wherein the cubic SiC crystal thin film is formed using an organosilicon gas having a Si—H bond and a Si—C bond.

12. The manufacturing method according to claim 11, wherein the organosilicon gas comprises at least one of monomethylsilane, dimethylsilane, and trimethylsilane.

13. A thin film structure comprising:
a Si substrate;
a cubic SiC crystal thin film having a (111) orientation formed on the Si substrate; and
a graphene or graphite thin film formed on the cubic SiC crystal thin film that is used as a base material.

14. The thin film structure according to claim 13, wherein the cubic SiC crystal thin film is a SIC thin film formed on a Si substrate.

15. The thin film structure according to claim 13, wherein the cubic SiC crystal thin film is a SiC thin film formed on a Si(110) substrate.

16. An electronic device comprising the graphene or graphite thin film according to claim 1.

17. An electronic device comprising the thin film structure according to claim 13.
